(19) United States
(12) Patent Application Publication
(10) Pub. No.: US 2007/0208888 A1
(43) Pub. Date: Sep. 6, 2007

(54) Method for allowing burners to burn partly different contents while copying source disc

(75) Inventor: Hong-Chuan Wang, Zhonghe City (TW)

Correspondence Address: BRUCE H. TROXELL, SUITE 1404, 5205 LEESBURG PIKE, FALLS CHURCH, VA, 22041, US

(73) Assignee: EPO Science & Technology Inc.

(21) Appl. No.: 11/356,119

(22) Filed: Feb. 17, 2006

(51) Int. Cl. G06F 13/00

(52) U.S. Cl. 710/33

(57) ABSTRACT

A method for allowing burners to burn partly different contents while coping a source disc is to allow a destination disc to have a section of specific area for recording data with partly different contents when the recorded data of the source disc are copied thereon, data with different contents are recorded to a specific area of the destination disc to cause the destination discs to have parts of contents different from the source disc while the copy operation is processed up to a starting address of the specific area. Whereby, each copied disc has data with partly different contents.

### FIELD OF THE INVENTION

The present invention relates to a method for allowing burners to copy a source disc, and more particularly to a method for recording partly different contents while allowing burners to masscopy a source disc at the same time.

### DESCRIPTION OF RELATED ART

Generally, when a source disc is masscopied, the source disc is first produced, and the recorded data of source disc is then allowed to copy to a great amount of discs by utilizing the disc punching technology. The destination discs and the source disc have the same-recorded data.

Taiwan Patent No. 283,286 discloses a burning device with disc cassettes, in which a box has a plurality of parallel cassettes installed therein; the cassettes can be moved in and out of the box, and the box is allowed to connect to an outside burner and the burner to connect to a computer mainframe so as to select a disc in any cassette in the box to process burning; the discs are burned one by one in a sequence or different data are burned on the discs at different locations by the driving of the computer mainframe after the discs are placed in the cassettes of the box.

For preventing an source disc from being illicitly copied, there are many patents proposed for protect the disc from illicit copy, such as U.S. Pat. No. 6,928,040 disclosing identifying a copy protected optical compact discs, U.S. Pat. No. 6,535,858 disclosing an optical disc copy management system and U.S. Pat. No. 6,188,659 disclosing a method for insuring uniqueness of an original CD.

General software recorded in a disc is attached with an installment serial number. When the software is going to be installed in a personal computer, it is normally required to input the installment serial number and the installment can then continue being executed in the process of executing the installment.

The same contents without difference are recorded in each of destination discs or discs copied by the technology disclosed in the Taiwan patent mentioned above. Because there is no difference between each disc, only one serial number can allow all software copied respectively on each disc to be installed in a personal computer.

### SUMMARY OF THE INVENTION

For allowing a burner to record partly different contents while coping a source disc and the contents recorded in each destination disc to be different, the present invention is proposed.

The main object of the present invention is to provide a method for allowing burners to burn partly different contents while copying a source disc, allowing the contents recorded on each destination disc to be different in some parts while masscopying the source disc at the same time.

Another object of the present invention is to provide a method for allowing burners to burn partly different contents while copying a source disc, allowing the contents recorded on each destination disc to be different in some parts and rather being able to cause illicitly destination discs to lose effectiveness.

### BRIEF DESCRIPTION OF THE DRAWINGS The present invention can be more fully understood by reference to the following description and accompanying drawings, in which:

FIG. 1 is a block diagram, showing devices for practicing the present invention; and

FIG. 2 is a flow chart of the present invention.

### DETAILED DESCRIPTION OF THE PREFERRED EMBODIMENTS

The present invention is to allow a destination disc to have a section of specific area for recording data with partly different contents, for example, a programs presuming the serial number mentioned above when the destination disc is copied with recorded data. The data at the specific area of the source disc is not copied to a destination disc and data with different contents is recorded to a specific area of the destination disc to cause the destination disc to have parts of contents different from the source disc and all destination discs also have parts of contents different from one another when the source disc is masscopied and a starting address of the specific area is reached.

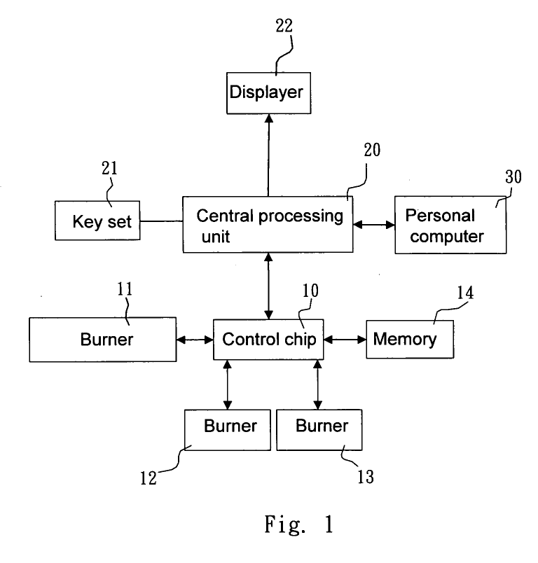

Please refer to FIG. 1. The present invention is to apply a control chip 10 to connect electrically respectively to a plurality of burners 11, 12 and 13, a memory 14 and a central processing unit 20. The central processing unit 20 is further connected electrically to key set 21 and a displayer 22. Besides, the central processing unit 20 can also be connected electrically to a personal computer 30.

A user can utilize the personal computer 30 or the key set 21 to input data with different contents; the data with different contents is used to record to a specific area on each destination disc. The displayer 22 can show the data with different contents. The central processing unit 20 allows the data with different contents to store in the memory 14 electrically connected to the control chip 10. When the copy of a disc is processed, the central processing unit 20 causes the control chip 10 to control the burner 11 for example to read the copied data stored in the source disc and the copied data to store in the memory 14, and meanwhile confirms the starting address and the length of a specific area used for storing data with partly different contents, and then causes the control chip 10 to control the burners 12 and 13 to process the burning operation of the copied data at the same time. When the burners 12 and 13 burns the disc up to the starting address of the specific area, the data with different contents is then copied to the specific area of each destination disc in a sequence to cause each destination disc to record the data with partly different contents. And, most other contents of each destination disc are same as the contents recorded on the source disc except the data with partly different contents.

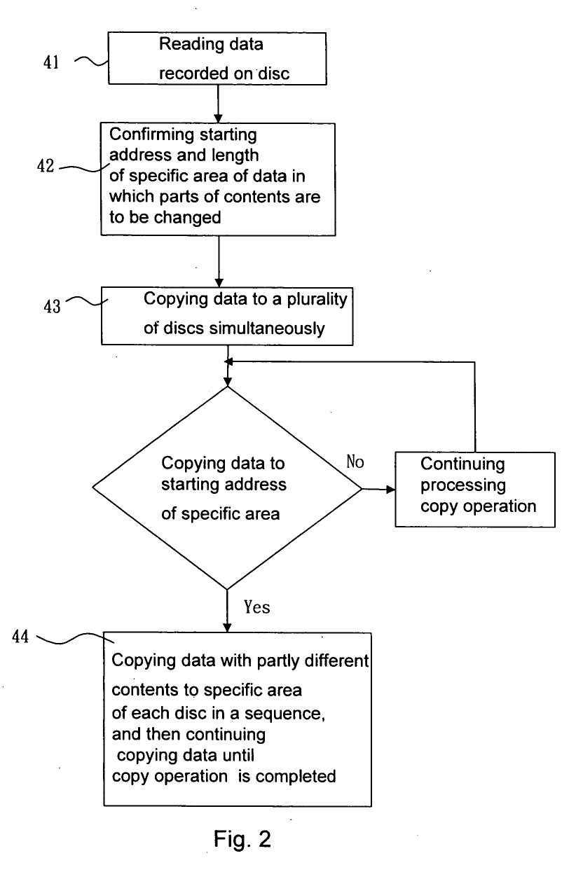

Please refer to FIG. 2. FIG. 2 shows a method for allowing burners to burn partly different contents while copying a disc; the steps thereof are as the followings:
Step 41: enabling the central processing unit 20 to allow the control chip 10 to control the burner 11 to read data recorded on a disc, and storing the data in the memory 14;
Step 42: causing the control chip 10 to confirm a starting address and length of a specific area in the data in which parts of contents want to be changed;
Step 43: causing the control chip 10 to control the burners 12 and 13 to process the copying operation at the same time; and
Step 44: controlling the burners 12 and 13 to enable each burner to copy a plurality of data with partly different contents pre-stored in the memory 14 to a specific area on the destination discs in a sequence when the burners 12 and 13 burn the destination discs up to the starting address of the specific area thereon, and then continuing the copy operation until the copy of the data is completed.

Using the method according to the present invention allows each destination disc to record data with partly different contents to cause each disc to be different from one another when the source disc is masscopied at the same time. For example, each disc is allowed to have a program differentiating a unique serial number, only input this unique serial number, a personal computer can then continue executing an installment operation to cause each serial number is accurately corresponding to the unique disc when the software recorded on the disc is going to be installed in the personal computer. The present invention allows the contents of the data recorded on each disc to be different; this can rather cause an illicitly copied disc to lose effectiveness.

The present invention allows a software company to enable each disc to have data with partly different contents conveniently while manufacturing fewer amounts of discs so as to be convenient on the management of the discs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for allowing burners to burn partly different contents while coping a source disc, used for causing each destination disc to record data with partly different contents when the source disc is masscopied, comprising the following steps:
(a) enabling a central processing unit to allow a control chip to control a burner to read data recorded in a optical compact disc and storing said data in a memory;
(b) allowing said control chip to confirm a starting address of a specific area in which parts of contents of said data are to be changed;
(c) allowing said control chip to control a plurality of burners to process a copy operation simultaneously; and
(d) when said starting address of a specific area in which parts of contents of said data are to be changed is reached, allowing said control chip to control said burners to cause each said burner to copy a plurality of data with partly different contents on a specific area of each destination disc in a sequence, thereafter, continuing copy operation until the cop of said data is completed;
whereby, said destination discs record data with partly different contents.

2. The method according to claim 1, wherein said data with partly different contents are pre-stored in said memory.

3. The method according to claim 2, wherein said data with partly different contents are pre-stored in said memory by means of the transmission of a personal computer.

4. The method according to claim 2, wherein said data with partly different contents are pre-stored in said memory by operating a key set.

5. The method according to claim 1, wherein said Step (b) further comprise: allowing said control chip to confirm the length of said specific area.
